(19) United States
(12) Patent Application Publication
(10) Pub. No.: US 2021/0014427 A1
(43) Pub. Date: Jan. 14, 2021

(54) CONTROL DEVICE, IMAGING DEVICE, MOBILE OBJECT, CONTROL METHOD AND PROGRAM

(71) Applicant: SZ DJI TECHNOLOGY CO., LTD., Shenzhen (CN)

(72) Inventors: Kenichi HONJO, Shenzhen (CN); Ming SHAO, Shenzhen (CN)

(21) Appl. No.: 17/033,869

(22) Filed: Sep. 27, 2020

Related U.S. Application Data
(63) Continuation of application No. PCT/CN2019/083679, filed on Apr. 22, 2019.

(30) Foreign Application Priority Data
Apr. 26, 2018 (JP) 2018-085848

(51) Int. Cl. H04N 5/232; H04N 5/265; H04N 5/225; G06T 7/70; H04N 7/18; B64C 39/02; B64D 47/08; G05D 1/00; G02B 7/36; G03B 15/00

(52) U.S. Cl. CPC H04N 5/23299; H04N 5/232123; H04N 5/265; H04N 5/2253; H04N 5/23203; G06T 7/70; H04N 5/247; B64C 39/024; B64D 47/08; G05D 1/0094; G02B 7/36; G03B 15/006; G06T 2207/10032; H04N 7/185

(57) ABSTRACT

A control device includes a processor and a storage medium storing instructions that cause the processor to control an imaging device to capture a plurality of images while an imaging direction of the imaging device is changing, determine a target imaging direction of the imaging device that satisfies a predetermined condition based on the plurality of images, and control the imaging device to perform additional image capturing while further changing the imaging direction, including performing image capturing at a first image capture angle rate while the imaging direction is in a first angle range not including the target imaging direction and performing image capturing at a second image capture angle rate while the imaging direction is in a second angle range including the target imaging direction. The second image capture angle rate correspond to more images captured per unit angle than the first image capture angle rate.

### CROSS-REFERENCE TO RELATED APPLICATIONS

This application is a continuation of International Application No. PCT/CN2019/083679, filed on Apr. 22, 2019, which claims priority to Japanese Application No. 2018-085848, filed Apr. 26, 2018, the entire contents of both of which are incorporated herein by reference.

### TECHNICAL FIELD

The present disclosure relates to a control device, an imaging device, a mobile object, a control method, and a program.

### BACKGROUND

WO 2017-006538 discloses an imaging device, which can cause an image processing unit to generate dynamic image data while moving the focus position of an optical system, and extract a still image focused on a specified area from a plurality of image frames included in the dynamic image data.

### SUMMARY

In accordance with the disclosure, there is provided a control device including a processor and a storage medium storing instructions that cause the processor to control an imaging device to capture a plurality of images while an imaging direction of the imaging device is changing, determine a target imaging direction of the imaging device that satisfies a predetermined condition based on the plurality of images, and control the imaging device to perform additional image capturing while further changing the imaging direction, including performing image capturing at a first image capture angle rate while the imaging direction is in a first angle range not including the target imaging direction and performing image capturing at a second image capture angle rate while the imaging direction is in a second angle range including the target imaging direction. The second image capture angle rate correspond to more images captured per unit angle than the first image capture angle rate.

Also in accordance with the disclosure, there is provided a control device including a processor and a storage medium storing instructions that cause the processor to control an imaging device to capture a plurality of images during a movement of the imaging device along a trajectory, determine a target position of the imaging device satisfying a predetermined condition based on the plurality of images, and control the imaging device to perform additional image capturing while further moving along the trajectory, including performing image capturing at a first image capture distance rate while the imaging device is in a first range of the trajectory not including the target position and performing image capturing at a second image capture distance rate while the imaging device is in a second range of the trajectory including the target position. The second image capture distance rate corresponds to more images captured per unit movement distance than the first image capture distance rate.

Also in accordance with the disclosure, there is provided a control device including a processor and a storage medium storing instructions that cause the processor to control a measuring device, which is configured to measure an object present in an imaging direction of an imaging device, to measure a plurality of measurement values during a change of a measurement direction of the measuring device, determine a target measurement direction of the measuring device satisfying a predetermined condition based on the plurality of measurement values, and control the imaging device to perform image capturing while changing the imaging direction corresponding to the change of the measurement direction, including performing image capturing at a first image capture angle rate while the imaging direction is in a first angle range not including the target measurement direction and performing image capturing at a second image capture angle rate while the imaging direction is in a second angle range including the target measurement direction. The second image capture angle rate corresponds to more images captured per unit angle than the first image capture angle rate.

Also in accordance with the disclosure, there is provided a control device including a processor and a storage medium storing instructions that cause the processor to control a measuring device to measure a plurality of measurement values during a movement of the measuring device along a trajectory, determine a target measurement position of the measuring device satisfying a predetermined condition based on the plurality of measurement values, and control an imaging device to perform image capturing while moving along the trajectory, including performing image capturing at a first image capture distance rate while the imaging device is in a first range of the trajectory not including the target measurement position and performing image capturing at a second image capture distance rate while the imaging device is in a second range of the trajectory including the target measurement position. The second image capture distance rate corresponds to more images captured per unit movement distance than the first image capture distance rate.

Also in accordance with the disclosure, there is provided an imaging device including any of the above-described control device and an image sensor controlled by the control device.

Also in accordance with the disclosure, there is provided a mobile object including the above-described imaging device and a support mechanism configured to support the imaging device and control an attitude of the imaging device.

### BRIEF DESCRIPTION OF THE DRAWINGS

FIG. 1 is a diagram illustrating an example of an appearance of an unmanned aerial vehicle (UAV) and a remote controller according to an embodiment of the present disclosure.

FIG. 2 is a diagram illustrating an example of functional blocks of a UAV according to an embodiment of the present disclosure.

FIG. 3 is a diagram for explaining an imaging method of a panoramic dynamic image photograph mode according to an embodiment of the present disclosure.

FIG. 4 is a diagram for explaining the imaging method of the panoramic dynamic image photograph mode according to an embodiment of the present disclosure.

FIG. 5A is a diagram illustrating an example of a relationship between an evaluation value of a contrast in a specific imaging direction and a lens position of a focus lens according to an embodiment of the present disclosure.

FIG. 5B is a diagram illustrating an example of the relationship between the evaluation value of the contrast in a specific imaging direction and the lens position of the focus lens according to an embodiment of the present disclosure.

FIG. 5C is a diagram illustrating an example of the relationship between the evaluation value of the contrast in a specific imaging direction and the lens position of the focus lens according to an embodiment of the present disclosure.

FIG. 6 is a diagram illustrating an example of a relationship between a rotation speed and a rotation angle in the panoramic dynamic image photograph mode according to an embodiment of the present disclosure.

FIG. 7 is a diagram for explaining image capturing by an imaging device according to an embodiment of the present disclosure.

FIG. 8 is a diagram illustrating an example of the relationship between the rotation speed and the rotation angle in the panoramic dynamic image photograph mode according to an embodiment of the present disclosure.

FIG. 9 is a diagram illustrating an example of a relationship between a frame rate and the rotation angle in the panoramic dynamic image photograph mode according to an embodiment of the present disclosure.

FIG. 10 is a diagram illustrating an example of a measurement result of a measured distance of an object to be imaged in association with the rotation angle according to an embodiment of the present disclosure.

FIG. 11 is a flowchart illustrating an example of an imaging procedure in the panoramic dynamic image photograph mode according to an embodiment of the present disclosure.

FIG. 12 is a flowchart illustrating an example of the imaging procedure in the panoramic dynamic image photograph mode according to an embodiment of the present disclosure.

FIG. 13 is a diagram for explaining an image captured by the imaging device according to an embodiment of the present disclosure

FIG. 14 is a diagram illustrating an example of a hardware configuration according to an embodiment of the present disclosure.

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure. It should be noted that technical solutions provided in the present disclosure do not require all combinations of the features described in the embodiments of the present disclosure.

The various embodiments of the present disclosure can be described with reference to the accompanying flowcharts and block diagrams, and the blocks herein may represent (1) a state of a process of performing an operation, or (2) a part of a device having an effect of performing an operation. Specific stages and parts can be implemented using programmable circuits and/or processors. Dedicated circuits may include digital and/or analog hardware circuits, which may include integrated circuits (ICs) and/or discrete circuits. The programmable circuit can include reconfigurable hardware circuitry, which can include logic AND, logic OR, logic XOR, logic NAND, login NOR, and other logic operations, flip-flops, registers, field programmable gate arrays (FPGAs), programmable logic arrays (PLAs), and the like.

The computer readable medium can include any tangible device that can store instructions that are executed by a suitable device. As such, a computer readable medium having instructions stored therein is provided with a product including executable instructions for forming means for performing the operations specified in the flowchart or block diagram. As an example, the computer readable medium may include an electronic storage medium, a magnetic storage medium, an optical storage medium, an electromagnetic storage medium, a semiconductor storage medium, or the like. As a more specific example, the computer readable medium may include a floppy (registered trademark) disk, a hard disk, a random access memory (RAM), a read only memory (ROM), an erasable programmable read only memory (EPROM or flash memory), electrically erasable programmable read only memory (EEPROM), static random access memory (SRAM), compact disc read only memory (CD-ROM), digital versatile disc (DVD), Blu-ray® disc, memory stick, integrated circuit card, or the like.

The computer readable instructions can include any of the source code or object code described in any combination of one or more programming languages. The source code or object code can include an existing procedural programming language. Existing procedural programming languages may be assembler instructions, instruction set architecture (ISA) instructions, machine instructions, machine dependent instructions, microcode, firmware instructions, state setting data, Smalltalk, JAVA (registered trademark), object-oriented programming language such as C++, and “C” programming language or the same programming language. The computer readable instructions may be provided locally or via a wide area network (WAN), such as a local area network (LAN), the Internet, to a processor or programmable circuit of a general purpose computer, special purpose computer, or other programmable data processing apparatus. The processor or programmable circuitry can execute computer readable instructions to form a means for performing the operations specified in the flowcharts or block diagrams. Examples of the processor include a computer processor, a processing unit, a microprocessor, a digital signal processor, a controller, a microcontroller, and the like.

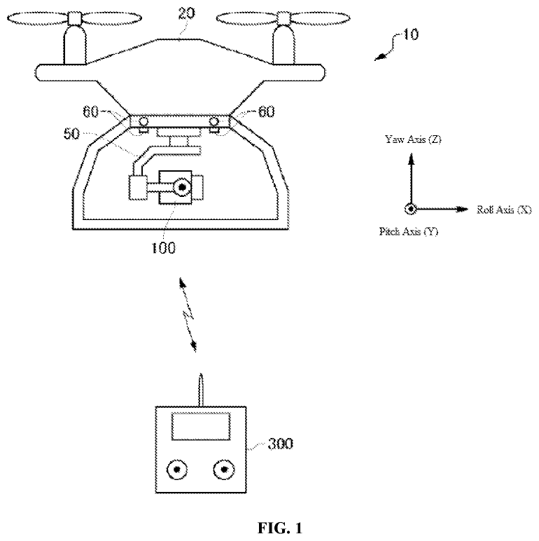

FIG. 1 is a diagram illustrating an example of an unmanned aerial vehicle (UAV) 10 and a remote controller 300 according to an embodiment of the present disclosure. The UAV 10 includes a UAV body 20, a gimbal 50, a plurality of imaging devices 60, and an imaging device 100. In some embodiments, the gimbal 50 and the imaging device 100 may be examples of an imaging system. The UAV 10 may be an example of a mobile object. A mobile object may include, for example, a flight object movable in the air, a vehicle movable on the ground, a ship movable on the water, etc. A flight object moving in the air may include, e.g., a UAV, or another aircraft, airship, or helicopter that is movable in the air.

The UAV body 20 includes a plurality of rotors. In some embodiments, the plurality of rotors may be an example of the propulsion system. The UAV body 20 can cause the UAV 10 to fly by controlling the rotation of the plurality of rotors. For example, the UAV body 20 can use four rotors to cause the UAV 10 to fly. The number of the rotors is not limited to four. In addition, the UAV 10 can also be a rotorless fixed wing aircraft.

The imaging device 100 may be an imaging camera for acquiring images of an object included in a desired imaging range. The gimbal 50 may be used to support the imaging device 100 in a rotatable manner. In some embodiments, the gimbal 50 may be an example of a support mechanism. For example, the gimbal 50 can support the imaging device 100 by rotating around the pitch axis by using an actuator. Further, using the actuator, the gimbal 50 can support the imaging device 100 by rotating around the roll axis and the yaw axis, respectively. In some embodiments, the gimbal 50 can change the attitude of the imaging device 100 by rotating the imaging device 100 around at least one of the yaw axis, the pitch axis, and the roll axis.

The plurality of imaging devices 60 may be the sensing cameras that are configured to acquire images of the surroundings of the UAV 10 in order to control the flight of the UAV 10. In some embodiments, two imaging devices 60 may be disposed at the head of the UAV 10 (i.e., the front side), and two imaging devices 60 can be disposed at the bottom side of the UAV 10. The two imaging devices 60 on the front side may be paired and function as a so-called stereo camera. Similar, the two imaging devices 60 on the front side may be paired and function as a so-called stereo camera. The imaging device 60 is an example of a measuring device for measuring an object present in the imaging direction of the imaging device 100. The measuring device may also include other sensors, such as an infrared sensor, an ultrasonic sensor, etc., for measuring an object present in the imaging direction of the imaging device 100. In some embodiments, three-dimensional spatial data around the UAV 10 may be generated based on the images acquired by the plurality of imaging devices 60. In particular, the number of the imaging devices 60 disposed at the UAV 10 may not be limited to four. The UAV 10 may include at least one imaging device 60. In some embodiments, the UAV 10 may include at least one imaging device 60 at each of the head, the tail, the bottom side, and the top side of the UAV 10. In some embodiments, the configurable viewing angle of the imaging device 60 may be greater than the configurable viewing angle of the imaging device 100. Further, the imaging device 60 can also have a fixed focus lens or a fisheye lens.

The remote controller 300 may communicate with the UAV 10 to remotely operate the UAV 10. The remote controller 300 may communicate with the UAV in a wireless manner. The remote controller 300 may transmit instruction information indicating various commands related to the movement of the UAV 10, such as ascending, descending, accelerating, decelerating, forwarding, backing, and rotating of the UAV 10. The instruction information may include, for example, instruction information to cause the UAV 10 to increase the height of the UAV 10. In some embodiments, the instruction information may indicate the height at which the UAV should be at. As such, the UAV 10 may move to the height indicated by the instruction information received from the remote controller 300. Further, the instruction information may include an ascending instruction to cause the UAV 10 to ascend. As such, the UAV 10 may ascend while receiving the ascending instruction. In some embodiments, when the UAV 10 receives the ascending instruction, but the height of the UAV 10 has reached an ascending limit, the ascending may be limited.

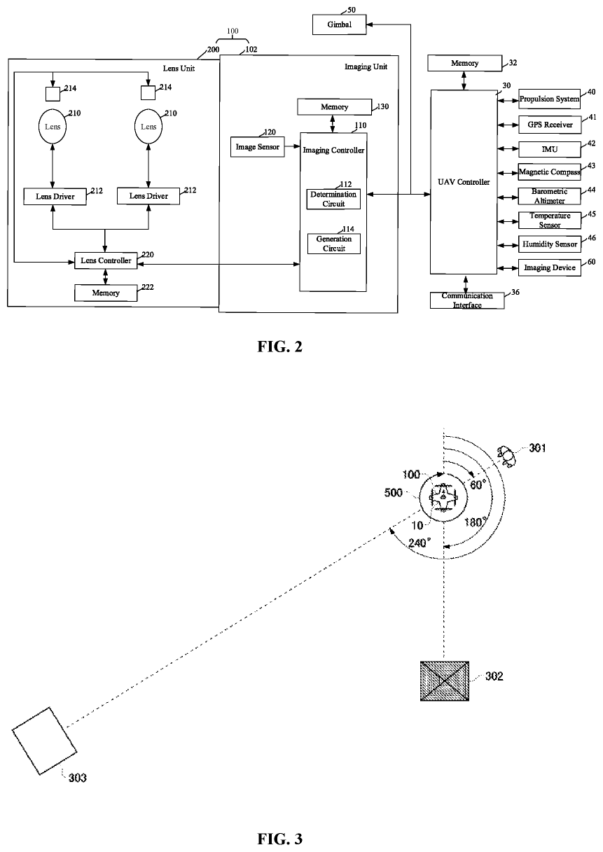

FIG. 2 is a diagram illustrating an example of functional blocks of the UAV 10 according to an embodiment of the present disclosure. The UAV 10 includes a UAV controller 30, a memory 32, a communication interface 36, a propulsion system 40, a GPS receiver 41, an inertial measurement unit (IMU) 42, a magnetic compass 43, a barometric altimeter 44, a temperature sensor 45, a humidity sensor 46, a gimbal 50, an imaging device 60, and an imaging device 100.

The communication interface 36 can communicate with other devices such as the remote controller 300. In some embodiments, the communication interface 36 can receive instruction information including various instructions for the UAV controller 30 from the remote controller 300. The memory 32 may store programs needed for the UAV controller 30 to control the propulsion system 40, the GPS receiver 41, the IMU 42, the magnetic compass 43, the barometric altimeter 44, the temperature sensor 45, the humidity sensor 46, the gimbal 50, the imaging device 60, and the imaging device 100. Further, the memory 32 may be a computer readable recording medium, and may include, e.g., at least one of an SRAM, a DRAM, an EPROM, an EEPROM, or a flash memory such as a USB memory. In some embodiments, the memory 32 may be disposed inside a UAV body 20. In other embodiments, the memory 32 may be configured to be detachable from the UAV body 20.

The UAV controller 30 can control the flight and imaging of the UAV 10 based on the program stored in the memory 32. The UAV controller 30 may include a microprocessor such as a central processing unit (CPU), a micro processing unit (MPU), or a microcontroller (MCU) or the like. In some embodiments, the UAV controller 30 may control the flight and imaging of the UAV 10 based on an instruction received from the remote controller 300 via the communication interface 36. The propulsion system 40 can drive the UAV 10. In some embodiments, the propulsion system 40 may include a plurality of rotors and a plurality of drive motors that rotate the plurality of rotors. Further, the propulsion system 40 may rotate the plurality of rotors by using the plurality of drive motors based on the instruction from the UAV controller 30 to cause the UAV 10 to fly.

The GPS receiver 41 may receive a plurality of signals indicating the time of transmission from a plurality of GPS satellites. The GPS receiver 41 may calculate the position (latitude and longitude) of the GPS receiver 41, that is, the position (latitude and longitude) of the UAV 10. The IMU 42 may detect the attitude of the UAV 10. In some embodiments, the IMU 42 may detect the acceleration in the three-axis directions of the front, rear, left, right, up, and down of the UAV 10, and the angular velocities of the three axes in the pitch, roll, and yaw directions. The magnetic compass 43 may detect the orientation of the heading of the UAV 10. The barometric altimeter 44 may detect the flying height of the UAV 10. In some embodiments, the barometric altimeter 44 may detect the air pressure around the UAV 10 and converts the detected air pressure to a height to detect the height. The temperature sensor 45 may detect the temperature around the UAV 10. The humidity sensor 46 may detect the humidity around the UAV 10.

The imaging device 100 includes an imaging unit 102 and a lens unit 200. The lens unit 200 may be an example of a lens device. The imaging unit 102 includes an image sensor 120, an imaging controller 110, and a memory 130. The imaging sensor 120 may include a CCD or a CMOS. The image sensor 120 may capture optical images formed through the plurality of lenses 210, and output the captured image data to the imaging controller 110. The imaging controller 110 may include a microprocessor such as a central processing unit (CPU), a micro processing unit (MPU), or a microcontroller (MCU) or the like. In some embodiments, the imaging controller 110 may control the imaging device 100 based on an operation instruction from the imaging device 100 of the UAV controller 30. The memory 130 may be a computer readable recording medium, and may include, e.g., at least one of an SRAM, a DRAM, an EPROM, an EEPROM, or a flash memory such as a USB memory. The memory 130 can store programs needed for the imaging controller 110 to control the image sensor 120 or the like. In some embodiments, the memory 130 may be disposed inside a housing of the imaging device 100. In other embodiments, the memory 130 may be disposed to be detachable the housing of the imaging device 100.

The lens unit 200 includes a plurality of lenses 210, a plurality of lens drivers 212, and a lens controller 220. The plurality of lenses 210 may function as a zoom lens, a varifocal lens, and a focus lens. In some embodiments, at least some or all of the plurality of lenses 210 may be configured to move along the optical axis. The lens unit 200 may be an interchangeable lens that can be detachably disposed with respect to the imaging unit 102. The plurality of lens drivers 212 may move at least some or all of the plurality of lenses 210 along the optical axis via a mechanism such as a cam ring. The lens driver 212 may include an actuator. The actuator may include a stepper motor. The lens controller 220 may drive the plurality of lens drivers 212 based on a lens control instruction from the imaging unit 102 to move one or more lenses 210 along the optical axis direction via the components of the mechanism. The lens control instruction may include, for example, a zoom control instruction and a focus control instruction.

The lens unit 200 further includes a memory 222 and a position sensor 214. The lens controller 220 may control the movement of the lenses 210 in the optical axis direction via the lens driver 212 based on the lens control instruction from the imaging unit 102. Some or all of the lenses 210 may move along the optical axis. The lens controller 220 may be configured to perform at least one of a zooming action and a focusing action by moving at least one of the lenses 210 along the optical direction. The position sensor 214 may detect the position of the plurality of lenses 210. The position sensor 214 may detect the current zoom position or the current focus position.

The lens driver 212 may include a vibration correction mechanism. The lens controller 220 may be configured to move the lens 210 in a direction along the optical axis or a direction perpendicular to the optical axis via the vibration correction mechanism to perform vibration correction. The lens driver 212 may drive the vibration correction mechanism by using a stepper motor to perform vibration correction. In addition, the vibration correction mechanism may be driven by a stepper motor to move the image sensor 120 in a direction along the optical axis or a direction perpendicular to the optical axis to perform vibration correction.

The memory 222 may store control values of the plurality of lenses 210 movable by the plurality of lens drivers 212. The memory 222 may include, e.g., at least one of an SRAM, a DRAM, an EPROM, an EEPROM, or a flash memory such as a USB memory.

As such, the imaging device 100 mounted at the UAV 10 configured in the above manner may suppress the data volume of the image captured by the imaging device 100, and capture the desired image more reliably.

The imaging controller 110 includes a determination circuit 112 and a generation circuit 114. The imaging controller 110 may cause the imaging device 100 to capture a plurality of images while the imaging direction of the imaging device 100 is changing. The imaging controller 110 may change the lens position of the focus lens within a range of a predetermined lens position via the lens controller 220, and at the same time, cause the imaging device 100 to capture a plurality of images while the imaging direction of the imaging device 100 is changing. The imaging controller 110 may change the lens position of the focus lens from the infinity far end to the nearest end via the lens controller 220, and at the same time, cause the imaging device 100 to capture a plurality of images while the imaging direction of the imaging device 100 is changing.

The imaging controller 110 may cause the imaging device 100 to capture a plurality of images while the imaging device 100 rotates around a first point to change the imaging direction of the imaging device 100. The imaging controller 110 may cause the imaging device 100 to capture a plurality of images while the UAV 10 is rotating and hovering. The imaging controller 110 may cause the imaging device 100 to capture a plurality of images while UAV 10 is hovering at the first point while the imaging device 100 is rotating relative to the UAV 10 via the gimbal 50. The first point may be a point in a predetermined coordinate space. The first point may be defined by latitude and longitude. The first point may be defined by latitude, longitude, and altitude.

The imaging controller 110 may cause the imaging device 100 to capture a plurality of images while the imaging device 100 moves along a first trajectory. The imaging controller 110 may cause the imaging device 100 to capture a plurality of images while the UAV 10 flies along the first trajectory. The first trajectory may be a trajectory in a predetermined coordinate space. The first trajectory may be defined by a set of points defined by latitude and longitude. The first trajectory may be defined by a set of points defined by latitude, longitude, and altitude. The imaging direction of the imaging device 100 may be controlled with respect to the UAV 10 via the gimbal 50. During the flight of the UAV 10 along the first trajectory, the imaging direction of the imaging device 100 may be maintained at a predetermined angle with respect to the travelling direction of the UAV 10.

The determination circuit 112 may determine the imaging direction of the imaging device 100 that satisfies a predetermined condition. The imaging direction satisfying the predetermined condition is also referred to as a “target imaging direction” or a “satisfying imaging direction” of the imaging device 100. The determination circuit 112 may determine the imaging direction of the imaging device 100. In this imaging direction, the imaging device 100 may capture an object that satisfies the predetermined condition. The determination circuit 112 may determine the imaging direction of the imaging device 100 that satisfies the predetermined condition based on a purity of images captured by the imaging device 100 when the UAV 10 is hovering and rotating. During the rotation relative to the UAV 10, the determination circuit 112 may determine the imaging direction of the imaging device 100 that satisfies the predetermined condition based on a plurality of images captured by the imaging device 100.

The determination circuit 112 may determine the imaging direction of the imaging device 100 that satisfies predetermined conditions based on an evaluation value of the contrast derived from the plurality of images. The determination circuit 112 may determine the imaging direction in which the evaluation value of the contrast is greater than a threshold value as the imaging direction of the imaging device 100 that satisfied the predetermined condition. The determination circuit 112 may determine the imaging direction in which the evaluation value of the contrast of a predetermined area in the image is greater than the threshold value as the imaging direction of the imaging device 100 that satisfied the predetermined condition.

For example, the determination circuit 112 may divide each of the plurality of images into a plurality of regions, and derive the contract evaluation value for each region. The determination circuit 112 may derive the distribution of the evaluation value of the contrast of an object present in a specific direction while moving the region (ROI) from one side to the other side in the horizontal direction of the image. If the evaluation value of the highest contrast specified in the distribution of the evaluation value of the contrast of the object present in the specific direction is greater than the threshold value, the determination circuit 112 may determine the specific direction as the imaging direction of the imaging device 100 that satisfied the predetermined condition.

The determination circuit 112 may determine the imaging direction of the imaging device 100 that satisfies the predetermined condition and a distance to an object present in the imaging direction of the imaging device that satisfies the predetermined condition based on the evaluation value of contrast derived from a plurality of images. The determination circuit 112 may determine the lens position of the focus lens when the image with the highest contrast evaluation value is captured based on the evaluation value of the contrast derived from the plurality of images. In addition, the determination circuit 112 may determine the distance to the object focused at the lens position of the specified focus lens as the distance to the object present in the imaging direction of the imaging device satisfying the predetermined condition.

The imaging controller 110 may cause the imaging device 100 to capture a plurality of images while the imaging device 100 rotates around the first point to change the imaging direction of the imaging device 100 in a first rotation of the imaging device. The imaging controller 110 may cause the imaging device 100 to capture a first number of first images per unit angle within the first angle range, and cause the imaging device 100 to capture a second number of second images more than the first number per unit angle within the second angle range in a second rotation after the first rotation of the imaging device when the imaging device 100 rotates around the first point. The number of images captured per unit angle is also referred to as an “image capture angle rate” of the imaging device 100. That is, the imaging controller 110 may cause the imaging device 100 to capture images at a first image capture angle rate within the first angle range and to capture images at a second image capture angle rate greater than the first image capture angle rate within the second angle range. The greater image capture angle rate corresponds to more images captured per unit angle.

The imaging controller 110 may cause the imaging device 100 to capture more images per unit angle than a first angle range that does not include the imaging direction of the imaging device 100 determined by the determination circuit 112 within in a second angle range including the imaging direction of the imaging device 100 specified by the determination circuit 112 during the change of the imaging direction of the imaging device 100.

The imaging controller 110 may control the lens position of the focus lens at a predetermined lens position within the first angle range via the lens controller 220 during the change of the imaging direction of the imaging device 100, and cause the imaging device 100 to capture a first number of first images per unit angle. The imaging controller 110 may control the lens position of the focus lens to infinity within the first angle range via the lens controller 220 during the change of the imaging direction of the imaging device 100, and cause the imaging device 100 to capture a first number of first images per unit angle. The imaging controller 110 may also control the lens position of the focus lens to the lens position based on the distance to the object via the lens controller 220 within the second angle range, and cause the imaging device 100 to capture the second number of second images, which may be greater than the first number per unit angle.

The imaging controller 110 may prevent the imaging device from performing imaging in the first angle range and perform imaging in the second angle range during the change of the imaging direction of the imaging device 100. The imaging controller 110 may control the number of images captured by the imaging device 100 per unit angle by controlling the frame rate of the imaging device 100 or the rotation speed of the imaging device 100.

During the movement of the imaging device 100 along the first trajectory and within a second range within the first trajectory including the position of the imaging device 100 determined by the determination circuit 112, the imaging controller 110 may control the imaging device 100 to capture more images per unit movement distance than a first range within the first trajectory that does not include the position of the imaging device 100 determined by the determination circuit 112. The position of the imaging device 100 determined by the determination circuit 112 as satisfying the predetermined condition is also referred to as a “target position” or a “satisfying position” of the imaging device 100. The number of images captured per unit movement distance is also referred to as an “image capture distance rate” of the imaging device 100. That is, the imaging controller 110 may cause the imaging device 100 to capture images at a first image capture distance rate within the first range of the first trajectory and to capture images at a second image capture distance rate greater than the first image capture distance rate within the second range of the first trajectory. The greater image capture distance rate corresponds to more images captured per unit movement distance. During the movement of the imaging device 100 along the first trajectory, the imaging controller 110 may cause the imaging device 100 to capture the first number of first images per unit time within the first range within the first trajectory, and cause the 100 to capture the second number of second images that are more than the first number per unit time within the second range within the first trajectory. The number of images captured per unit time is also referred to as a “frame rate” of the imaging device 100. That is, the imaging controller 110 may cause the imaging device 100 to capture images at a first frame rate within the first range of the first trajectory and to capture images at a second frame rate greater than the first frame rate within the second range of the first trajectory. The greater frame rate corresponds to more images captured per unit time.

The imaging controller 110 may control the number of images captured by the imaging device 100 per unit movement distance by controlling the frame rate of the imaging device 100 or the moving speed of the imaging device 100.

The imaging controller 110 may cause the measuring device to measure a plurality of measurement values while the measuring direction of the measuring device for measuring an object present in the imaging direction of the imaging device 100 is changing. The imaging controller 110 may cause the image device 60 to capture a plurality of images as a plurality of measurement values while the imaging direction of the imaging device 60 that functions as a stereo camera included in the UAV 10 is changing. The imaging controller 110 may cause the distance sensor to measure a plurality of measurement values while the measurement direction of the distance sensor, such as an infrared sensor or an ultrasonic sensor, included in the UAV 10 and can measure the distance from the object to the UAV 10 is changing.

In some embodiments, the determination circuit 112 may determine the measurement direction of the measuring device that satisfies a predetermined condition based on a plurality of measurement values measured by the measuring device. The measurement direction satisfying the predetermined condition is also referred to as a “target measurement direction” or a “satisfying measurement direction” of the measuring device. In some embodiments, the determination circuit 112 may determine the imaging direction of the imaging device 60 satisfying the predetermined condition or the position of the imaging device 60 satisfying the predetermined condition based on a plurality of images captured by the imaging device 60 functioning as a stereo camera. In some embodiments, the determination circuit 112 may determine the imaging direction of the imaging device 60 that can capture the object that satisfies the predetermined condition by the imaging device 100 as the imaging direction of the 60 satisfying the predetermined condition based on a plurality of images captured by the imaging device 60 functioning as a stereo camera. In some embodiments, the determination circuit 112 may specify the position of the UAV 10 on the first trajectory where the imaging device 100 can capture the object satisfying the predetermined condition as the position of the imaging device 60 satisfying the predetermined condition based on the plurality of images captured by the imaging device 60.

In some embodiments, the determination circuit 112 may determine the imaging direction of the imaging device 60 where a predetermined object is present or the position within the first trajectory based on the plurality of images captured by the imaging device 60. In some embodiments, the determination circuit 112 may determine the imaging direction of the imaging device 60 in which an object is present within a predetermined distance from the UAV 10, or the position within the first trajectory as the imaging direction of the imaging device 60 satisfying the predetermined condition, or the imaging device 60 satisfying the predetermined condition based on the plurality of images captured by the imaging device 60.

In some embodiments, the determination circuit 112 may cause the imaging device 100 to capture more images per unit angle than the first angle range that does not include the measurement direction of the measuring device determined by the determination circuit 112 while the imaging direction of the imaging device 100 is changing corresponding to the change of the measurement direction of the measuring device and within the second angle range including the measurement direction of the measuring device determined by the determination circuit 112.

In some embodiments, the imaging controller 110 may cause the imaging device 100 to capture the first number of first images per unit angle within the first angle range that does not include the measurement direction of the measuring device determined by the determination circuit 112. In some embodiments, the imaging controller 110 may cause the imaging device 100 to capture the second number of second images that may be greater than the first number per unit angle within the second angle range including the measurement direction of the measuring device determined by the determination circuit 112.

When the UAV 10 is hovering and it starts to rotate, the imaging direction of the imaging device 60 may start to change. Within a predetermined amount of time after the UAV 10 and the imaging device 60 start to rotate, the UAV controller 30 may control the attitude of the imaging device 100 via the gimbal 50, thereby not changing the imaging direction of the imaging device 100. Subsequently, the gimbal 50 may control the attitude of the imaging device 100, thereby not changing the imaging direction of the imaging device 100. The UAV controller 30 may control the UAV 10 and the gimbal 50 to maintain the angle between the imaging direction of the imaging device 60 and the imaging direction of the imaging device 100 at a predetermined angle.

In some embodiments, the imaging controller 110 may cause the imaging device 100 to capture more images per unit movement distance than the first range in the first trajectory that does not include the position of the measuring device determined by the determination circuit 112 during the movement of the imaging device 100 along the first trajectory and within the second range within the first trajectory including the position of the measuring device determined by the determination circuit 112. The position of the measuring device determined by the determination circuit 112 as satisfying the predetermined condition is also referred to as a “target measurement position” or a “satisfying measurement position” of the measuring device.

In some embodiments, the imaging controller 110 may cause the imaging device 100 to capture a first number of first images within the first range of the first trajectory during the movement of the imaging device 100 along the first trajectory. Further, the imaging controller 110 may cause the imaging device 100 to capture a second number of second images that may be greater than the first number within a second range of a second trajectory. In some embodiments, the imaging controller 110 may cause the imaging device 100 not to perform imaging in the first range within the first trajectory during the movement of the imaging device 100 along the first trajectory, but perform imaging in the second range within the first trajectory.

The generation circuit 114 may generate a composite image based on a plurality of images captured by the imaging device 100. The determination circuit 112 may generate a composite image based on the first image captured by the imaging device 100 within the first angle range and the second image captured by the imaging device 100 within the second angle range. In some embodiments, the determination circuit 112 may generate a composite image based on the first image captured by the imaging device 100 within the first range of the first trajectory and the second captured by the imaging device 100 within the second range of the first trajectory.

The generation circuit 114 may generate a panoramic dynamic image photo as a composite image, where the first image may be a sill image and the second image may be a dynamic image. In some embodiments, the generation circuit 114 may generate a panoramic dynamic image photo as a composite image, where the first image may be the background and the second image may be the dynamic image. In some embodiments, the generation circuit 114 may extract the second image determined by the user from a plurality of second images to generate a still image. In addition to the imaging unit 102, the generation circuit 114 may include, for example, the remote controller 300 and other personal computers.

As shown in FIG. 3, while the imaging device 100 rotates together with the UAV 10, for example, in a clockwise direction 500, the imaging device 100 can continuously capture images. In the example shown in FIG. 3, a first object 301 is present in the imaging direction of the imaging device 100 when the imaging device 100 is rotated by 60°. A second object 302 is present in the imaging direction of the imaging device 100 when the imaging device 100 is rotated by 180°. A third object 303 is present in the imaging direction of the imaging device 100 when the imaging device 100 is rotated by 240°. The determination circuit 112 may determine the imaging directions of the imaging device 100 where the first object 301, the second object 302, and the third object 303 are present based on a plurality of images captured while the imaging device 100 rotates. In some embodiments, the determination circuit 112 may determine, from the plurality of images captured when the imaging device 100 is rotating while changing the lens position of the focus lens of the imaging device 100, image(s) with an evaluation value of contrast above a threshold, according to respective contrast evaluation values of the plurality of images, and determine the imaging directions where the first object 301, the second object 302, and the third object 303 are present based on the image(s) with the evaluation value of contrast above the threshold.

For example, as shown in FIG. 4, while changing the lens position of the focus lens of the imaging device 100 from the nearest side to the infinity side, and then from the infinity side to the nearest side, every time the imaging device 100 rotates by 20°, the imaging device 100 captures an image, to obtain images I1 to I18. The viewing angle set in the imaging device 100 may be, for example, 130° or 135°. The determination circuit 112 may divide the images I1 to I18 captured by the imaging device 100 into a plurality of regions, and derive an evaluation value of contrast for each region (region of interest, ROI).

The determination circuit 112, for example, may move the region (ROI) for deriving the evaluation value of contrast of the image I1 to I18 from the right side to the left side of the image, while deriving the evaluation values of contrast of the object present in a specific direction. The determination circuit 112 may derive the distribution of the evaluation value of contrast of the object present in respective imaging directions. The determination circuit 112 may determine the distribution of focus positions where the evaluation value of contrast is greater than a predetermined threshold value from each distribution, and determine a specific direction corresponding to the specified distribution as an imaging direction in which an object satisfying a predetermined condition is present.

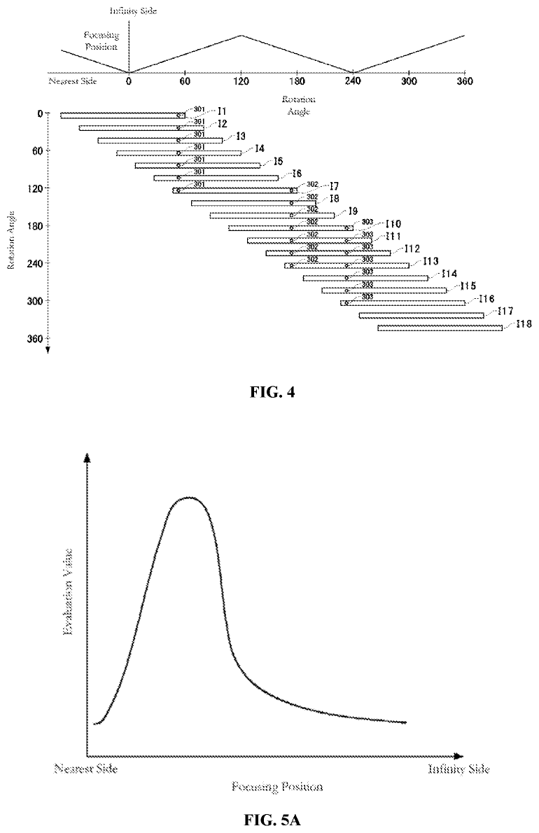

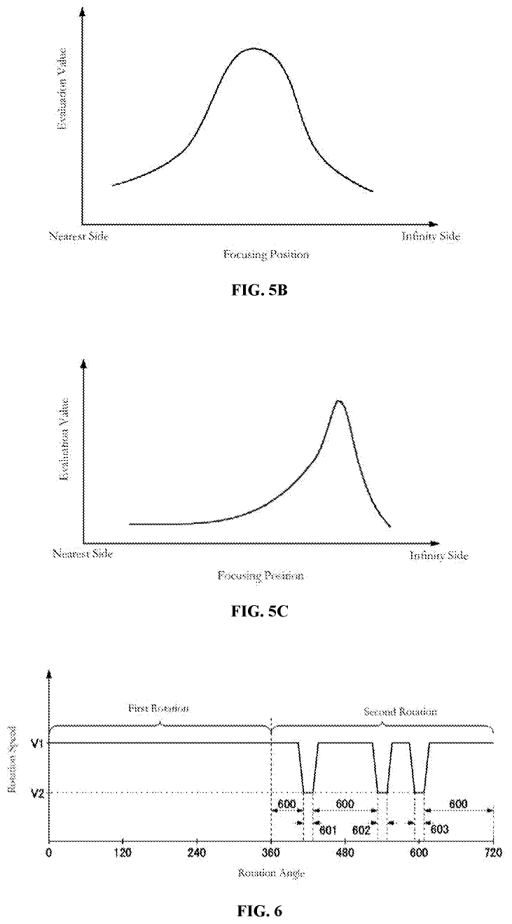

For example, the distribution shown in FIG. 5A is obtained as an evaluation value of contrast with respect to the object 301 present in the imaging direction when the imaging device 100 is rotated by 60°. The distribution shown in FIG. 5B is obtained as an evaluation value of contrast with respect to the object 302 present in the imaging direction when the imaging device 100 is rotated by 180°. The distribution shown in FIG. 5C is obtained as an evaluation value of contrast with respect to the object 303 present in the imaging direction when the imaging device 100 is rotated by 240°. The determination circuit 112 may determine the distance to the object by determining the focus position where the evaluation value of contrast is the highest from the respective distributions.

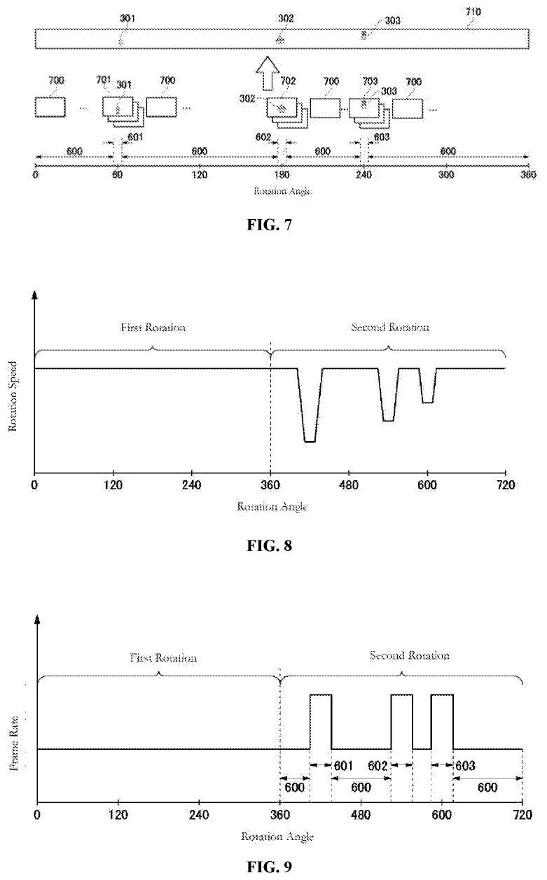

FIG. 6 is a diagram illustrating an example of a relationship between a rotation speed of the imaging device 100 and a rotation angle of the imaging device 100. During a first rotation, the imaging device 100 may rotate at a certain rotation speed V1 while changing the lens position of the focus lens to capture images at each predetermined angle. Based on the contrast evaluation values of these images, the determination circuit 112 may determine the imaging direction of the imaging device 100 at which the imaging device 100 can capture an object with a contrast evaluation value greater than the threshold value. Next, during a second rotation, the imaging device 100 may rotate at the rotation speed V1 within a range 600 that does not include the imaging direction determined by the determination circuit 112, and simultaneously capture a dynamic image at a predetermined first frame rate. Alternatively, during the second rotation, the imaging device 100 may rotate at the rotation speed V1 within ranges 600 that do not include the imaging directions determined by the determination circuit 112, while capturing still images at a predetermined first interval. The imaging device 100 may rotate at a rotation speed V2 slower than the rotation speed V1 within ranges 601, 602, and 603 including the imaging directions determined by the determination circuit 112, and simultaneously capture a dynamic image at the first frame rate.

FIG. 7 is a diagram for explaining image capturing by the imaging device 100. The imaging device 100 may capture more images per unit time in the ranges 601, 602, and 603 including the imaging directions determined by the determination circuit 112 than in the ranges 600 that do not include the imaging directions determined by the determination circuit 112. The imaging device 100 may capture a first number of first images 700 per unit time within the range 600 not including the imaging directions determined by the determination circuit 112, and capture a second number of second images 701, 702, and 703 per unit time within the ranges 601, 602, and 603 including the imaging directions determined by the determination circuit 112. The second number is greater than the first number. Based on these images, the generation circuit 114 may generate a panoramic dynamic image 710 in which the regions of the objects 301, 302, and 303 are dynamic images, and other regions are still images.

FIG. 8 is a diagram illustrating another example of the relationship between the rotation speed of the imaging device 100 and the rotation angle of the imaging device 100. The UAV controller 30 may change the rotation speed of the imaging device 100 by controlling the UAV 10 or the gimbal 50 based on the distance to an object satisfying a predetermined condition. The UAV controller 30 may change the rotation speed of the imaging device 100 by controlling the UAV 10 or the gimbal 50, such that the shorter the distance to the object, the slower the rotation speed of the imaging device 100.

FIG. 9 is a diagram illustrating an example of a relationship between a frame rate of the imaging device 100 and the rotation angle of the imaging device 100. During the first rotation, the imaging device 100 may rotate at the rotation speed V1, and at the same time change the lens position of the focus lens to capture dynamic images at a first frame rate. Based on the contrast evaluation values of these images, the determination circuit 112 may determine the imaging direction of the imaging device 100 at which the imaging device 100 can capture an object with a contrast evaluation value greater than the threshold value. Next, during the second rotation, the imaging device 100 may rotate at the rotation speed V1 within the range 600 that does not include the imaging direction determined by the determination circuit 112, and simultaneously capture a dynamic image at the first frame rate. The imaging device 100 may rotate at the rotation speed V1 within the ranges 601, 602, and 603 including the imaging directions determined by the determination circuit 112, and simultaneously capture dynamic images at a second frame rate higher than the first frame rate. Therefore, the imaging device 100 may capture more images per unit time in the ranges 601, 602, and 603 including the imaging directions determined by the determination circuit 112 than the range 600 that does not include the imaging direction determined by the determination circuit 112.

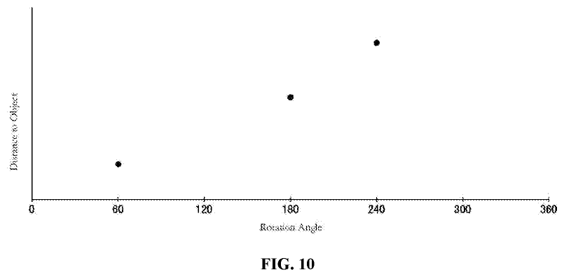

The determination circuit 112 may determine the direction in which an object is present within a predetermined distance from the UAV 10 as the imaging direction of the imaging device 100 satisfying the predetermined condition, based on the measurement result of a sensor that measures the distance from the object to the imaging device 60 functioning as a stereo camera. FIG. 10 is a diagram illustrating an example of the result of the distance to the object measured by the imaging device 60 while the imaging device 100 is rotating. Based on the result shown in FIG. 10, the determination circuit 112 may determine the imaging direction when the imaging device 100 is rotated by 60°, the imaging direction when the imaging device 100 is rotated by 180°, and the imaging direction when the imaging device 100 is rotated by 240° as the imaging directions of the imaging device 100 satisfying the predetermined condition.

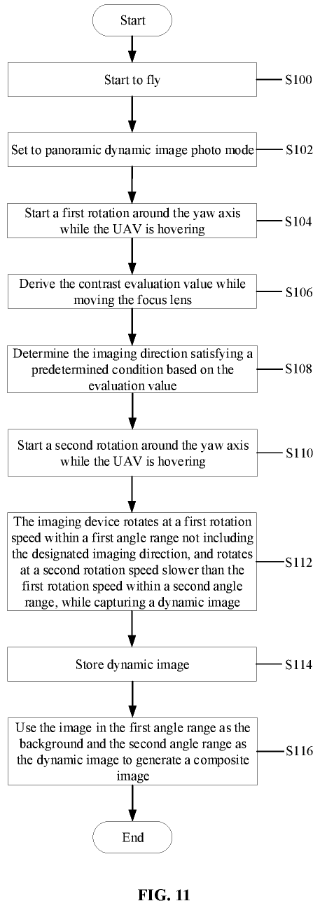

FIG. 11 is a flowchart illustrating an example of a procedure when the UAV 10 operates in the panoramic dynamic image photograph mode.

At S100, the UAV 10 starts to fly. The user sets the imaging mode of the imaging device 100 to the panoramic dynamic image photograph mode via the remote controller 300 (S102). In some embodiments, before the UAV 10 starts to fly, the imaging mode of the imaging device 100 may be set to the panoramic dynamic image photograph mode via the operation member of the UAV 10 or the operation member of the imaging device 100.

When the UAV 10 reaches the desired position, the UAV 10 starts a first rotation around the yaw axis while hovering (S104). The imaging direction of the imaging device 100 may be a direction intersecting the yaw axis. The angle between the imaging direction of the imaging device 100 and the direction along the yaw axis may be, for example, 30°, 60°, or 90°. One rotation may also include rotating from a specific place and then never returning to the specific place.

During the rotation of the UAV 10, the imaging device 100 moves the focus lens from the nearest side to the infinity side, while capturing images sequentially, and derives a contrast evaluation value in each imaging direction of the imaging device 100 (S106). The determination circuit 112 determines the imaging direction of the imaging device 100 satisfying a predetermined condition based on the contrast evaluation value (S108).

While hovering, the UAV 10 starts a second rotation around the yaw axis at the same place as that during the first rotation (S110). The imaging device 100 rotates at a first rotation speed within a first angle range that does not include the imaging direction determined by the determination circuit 112, and rotates at a second rotation speed slower than the first rotation speed within a second angle range including the imaging direction determined by the determination circuit 112, and captures a dynamic image while rotating (S112). The imaging device 100 stores the captured dynamic image in the memory 32 (S114). The generation circuit 114 generates a composite image based on the dynamic image stored in the memory 32 with the image in the first angle range as the background and the second angle range as the dynamic image (S116).

By using the above procedure, the imaging device 100 can capture more images in the periphery of the imaging direction where an image with a higher contrast evaluation value is likely to be obtained. As such, it is possible to reliably capture a desired image while suppressing the data amount of the image captured by the imaging device 100. The generation circuit 114 can use an image in the imaging direction with a relatively high contrast evaluation value as a dynamic image, and use an image in the imaging direction with a relatively low contrast evaluation value as a still image, and can generate a panoramic dynamic image photograph with a reduced amount of data.

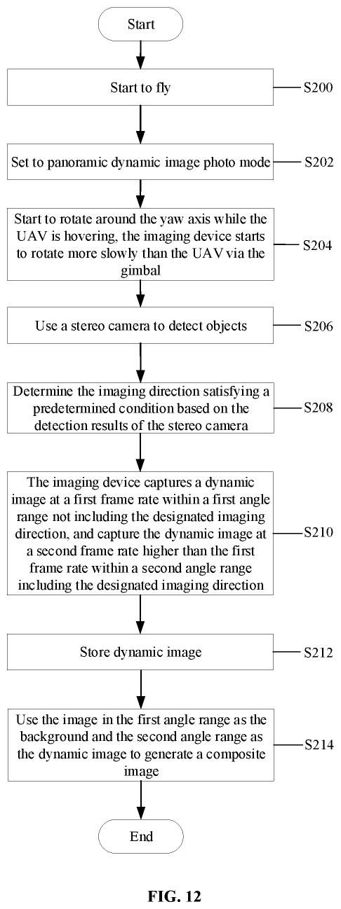

FIG. 12 is a flowchart illustrating an example of a program when UAV 10 operates in the panoramic dynamic image photograph mode.

At S200, the UAV 10 starts to fly. The user sets the imaging mode of the imaging device 100 to the panoramic dynamic image photograph mode via the remote controller 300 (S202). In some embodiments, before the UAV 10 starts to fly, the imaging mode of the imaging device 100 may be set to the panoramic dynamic image photograph mode via the operation member of the UAV 10 or the operation member of the imaging device 100.

When the UAV 10 reaches the desired position, the UAV 10 starts to rotate about the yaw axis while hovering, and the imaging device 100 starts to rotate more slowly than the UAV 10 via the gimbal 50 (S204).

The imaging device 60 functioning as a stereo camera mounted at the UAV 10 is used to detect an object satisfying a predetermined condition (S206). The imaging device 60 may detect an object present within a predetermined distance range from the UAV 10 as an object satisfying the predetermined condition. The determination circuit 112 determines the imaging direction of the imaging device 100 satisfying the predetermined condition based on the object detection result of the imaging device 60 (S208). The determination circuit 112 may determine the imaging direction of the imaging device 100 corresponding to the object present within the predetermined distance from the UAV 10 as the imaging direction of the imaging device 100 satisfying the predetermined condition.

While rotating more slowly than the UAV 10 and the imaging device 60, the imaging device 100 captures a dynamic image at the first frame rate within the first angle range that does not include the imaging direction determined by the determination circuit 112, and captures a dynamic image at the second frame rate higher than the first frame rate in the second angle range including the imaging direction determined by the determination circuit 112 (S210). The imaging device 100 stores the captured dynamic image in the memory 32 (S212). The generation circuit 114 generates a composite image based on the dynamic image stored in the memory 32 with the image in the first angle range as the background and the second angle range as the dynamic image (S214).

By using the above procedure, when the UAV 10 rotates, the imaging device 100 can determine the imaging direction in which the object satisfying the condition predetermined by the imaging device 60 is present, and at the same time, capture more images in the angle range including the determined imaging direction than other angle ranges. Therefore, it is possible to obtain a dynamic image that includes more images that are more likely to include the desired object than images that are less likely to include the desired object. Therefore, it is possible to reliably capture a desired image while suppressing the data amount of the image captured by the imaging device 100. In some embodiments, it is also possible to perform imaging using a method in which the imaging device 100 rotates, and the UAV 10 rotates more slowly than the rotation of the imaging device 100.

When the imaging device 100 performs imaging in an angle range or a trajectory range including the imaging direction satisfying the predetermined condition, the imaging controller 110 may adjust the lens position of the focus lens to the distance to perform focusing based on the distance from the object included in the imaging direction. The imaging controller 110 may adjust the lens position of the focus lens to infinity for focusing, and is not limited to the distance from the object included in the imaging direction. When the imaging device 100 performs imaging in an angle range or a trajectory range that does not include the imaging direction satisfying the predetermined condition, the imaging controller 110 may adjust the lens position of the focus lens to a predetermined lens position, for example, adjust the lens position of the focus lens to infinity for focusing.

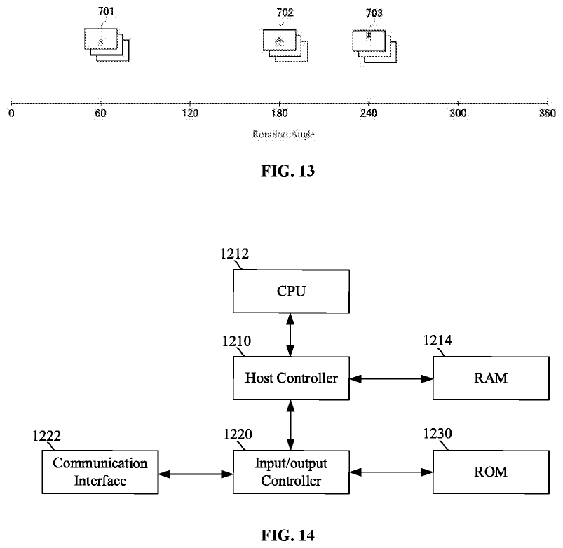

As shown in FIG. 13, the imaging device 100 may only perform imaging within an angle range or a trajectory range including the imaging direction satisfying the predetermined condition but not perform imaging within an angle range or a trajectory range that does not include the imaging direction satisfying the predetermined condition, i.e., the image capture angle rate within the angle range or the trajectory range that does not include the imaging direction satisfying the predetermined condition may be zero. Under these circumstances, for example, the generation circuit 114 may allow the user to select an image in a desired imaging state from the images 701, 702, and 703 constituting a dynamic image captured by the imaging device 100 within the angle range or trajectory range including the imaging direction satisfying the predetermined condition, and cut the image into a still image.

FIG. 14 is a diagram illustrating an example of a computer 1200 that may be configured to implement in whole or in part of the various aspects of the present disclosure. The program installed on the computer 1200 may be configured to cause the computer 1200 to perform the related operations of the device or one or more parts of the device according to the embodiments of the present disclosure. In some embodiments, the program may cause the computer 1200 to execute the operation or one or more parts of the operation. The program may cause the computer 1200 to execute the process or the steps of the process related to the embodiments of the present disclosure. The program can be executed by a CPU 1212 in order for the computer 1200 to execute a number of or all of the specific specified operations associated with the flowcharts and block diagrams of the present disclosure.

As shown in FIG. 14, the computer 1200 includes a CPU 1212 and a RAM 1214. The CPU 1212 and the RAM 1214 are connected to each other by a host controller 1210. The computer further includes a communication interface 1222, and an input/output unit. The communication interface 1222 and the input/output unit are connected to the host controller 1210 via an input/output controller 1220. The computer 1200 further includes ROM 1230. The CPU 1212 may be configured to perform operations in accordance with the program stored in the ROM 1230 and the RAM 1214, thereby controlling the respective units.

The communication interface 1222 may communicate with other electronic devices over a network. The hard disk drive can store programs and data for use by the CPU 1212 within the computer 1200. The ROM 1230 may store a boot program or the like executed by the computer 1200 at the time of boot up and/or a program dependent on the hardware of the computer 1200. The program may be provided by a computer readable recording medium such as a CD-ROM, a USB memory, or an IC card. Further, the program may be installed in the RAM 1214 or the ROM 1230, which may be an example of the computer readable recording medium, and executed by the CPU 1212. The information processing described within these programs may be read by the computer 1200 to cause cooperation between the programs and the various types of hardware resources. In some embodiments, device or method may be constructed by realizing the operation or processing of the information by using the computer 1200.

For example, when the communication is performed between the computer 1200 and an external device, the CPU 1212 can execute a communication program loaded on the RAM 1214 and instruct the communication interface 1222 to perform a communication processing based on the processing described in the communication program. Under the control of the CPU 1212, the communication interface 1212 may read the transmission data stored in a transmission buffer included in the recording medium such as the RAM 1214 or the USB memory, then transmit the read transmission data to the network, or write the received data received through the network to a reception buffer or the like included in the recording medium.

Moreover, the CPU 1212 may read all or a part of files or databases stored in an external recording medium such as a USB memory into the RAM 1214 and perform various types of processing on the data on the RAM 1214. Subsequently, the CPU 1212 may write the processed data back to the external recording medium.

Various types of information such as various types of programs, data, tables, and databases can be stored in a recording medium and subjected to information processing. The CPU 1212 can perform various types of processing on the data read from the RAM 1214 and write the results back into the RAM 1214. In some embodiments, the various types of processing may include various types of operations, information processing, conditional determinations, conditional branches, unconditional branches, retrieval/replacement of information, etc. specified by the instruction sequence of the program as described elsewhere in the present disclosure. In addition, the CPU 1212 can retrieve information in a file, a database, and the like in the recording medium. For example, when multiple entries having an attribute value of a first attribute related to an attribute value of a second attribute are stored in the recording medium, the CPU 1212 can retrieve an entry corresponding to the condition specified by the attribute value of the first attribute from the multiple entries and read the attribute value of the second attribute stored in the entry, thereby obtaining the attribute value of the second attribute related to the first attribute that satisfies the predetermined condition.

The program or software modules described above can be stored on the computer 1200 or in a computer readable storage medium near to the computer 1200. In addition, a recording medium such as a hard disk or a RAM included in a server system connected to a dedicated communication network or the Internet can be used as the computer readable storage medium. As such, the program can be provided to the computer 1200 through the network.

The technical solutions of the present disclosure have been described by using the various embodiments mentioned above. However, the technical scope of the present disclosure is not limited to the above-described embodiments. It should be obvious to one skilled in the art that various modifications and improvements may be made to the embodiments. It should also obvious from the scope of claims of the present disclosure that thus modified and improved embodiments are included in the technical scope of the present disclosure.

As long as terms such as “before,” “previous,” etc., are not specifically stated, and as long as the output of the previous processing is not used in the subsequent processing, the execution order of the processes, sequences, steps, and stages in the devices, systems, programs, and methods illustrated in the claims, the description, and the drawings may be implement in any order. For convenience, the operation flows in the claims, description, and drawing have been described using terms such as “first,” “next,” etc., however, it does not mean these steps must be implemented in this order.

Although the present disclosure has been described with reference to the embodiments, the technical scope of the present disclosure according to the present disclosure is not limited to the scope described in the above embodiments. It is apparent to those skilled in the art that various modifications or improvements can be added to the above embodiments. It is also apparent that embodiments with such modifications or improvements can be included in the technical scope of the present disclosure.

### DESCRIPTION OF THE REFERENCE NUMERALS

10 UAV
20 UAV body
30 UAV controller
32 Memory
36 Communication interface
40 Propulsion system
41 GPS receiver
42 IMU
43 Magnetic compass
44 Barometric altimeter
45 Temperature sensor
46 Humidity sensor
50 Gimbal
60 Imaging device
100 Imaging device
102 Imaging unit
110 Imaging controller
112 Determination circuit
114 Generation circuit
120 Image sensor
130 Memory
200 Lens unit
210 Lens
212 Lens driver
214 Position sensor
220 Lens controller
222 Memory
300 Remote controller
1200 Computer
1210 Host controller
1212 CPU
1214 RAM
1220 Input/output controller
1222 Communication interface
1230 ROM

What is claimed is:

1. A control device comprising:
a processor; and
a storage medium storing instructions that, when executed by the processor, cause the processor to:
control an imaging device to capture a plurality of images while an imaging direction of the imaging device is changing;
determine a target imaging direction of the imaging device that satisfies a predetermined condition based on the plurality of images; and
control the imaging device to perform additional image capturing while further changing the imaging direction, including:
performing image capturing at a first image capture angle rate while the imaging direction is in a first angle range not including the target imaging direction; and
performing image capturing at a second image capture angle rate while the imaging direction is in a second angle range including the target imaging direction, the second image capture angle rate corresponding to more images captured per unit angle than the first image capture angle rate.

2. The control device of claim 1, wherein the instructions further cause the processor to determine the target imaging direction based on a contrast evaluation value derived from the plurality of images.

3. The control device of claim 1, wherein the instructions further cause the processor to control the imaging device to rotate around a point to change the imaging direction.

4. The control device of claim 1, wherein:
the imaging device includes a focus lens and a lens controller controlling a lens position of the focus lens; and
the instructions further cause the processor to:
change, via the lens controller, the lens position of the focus lens within a predetermined lens position range while the imaging direction of the imaging device is changing and cause the imaging device to capture the plurality of images;
determine the target imaging direction and a distance to an object present in the target imaging direction based on a contrast evaluation value derived from the plurality of images; and
control, via the lens controller and while the imaging direction is in the first angle range, the lens position of the focus lens at a predetermined lens position and cause the imaging device to perform image capturing at the first image capture angle rate, and control, via the lens controller and while the imaging direction is in the second angle range, the lens position of the focus lens at a lens position determined based on the distance to the object and cause the imaging device to perform imaging capturing at the second image capture angle rate.

5. The control device of claim 1, wherein the instructions further cause the processor to control an image capture angle rate of the imaging device by controlling a frame rate of the imaging device or a rotation speed of the imaging device.

6. The control device of claim 1, wherein the second image capture angle rate is zero.

7. The control device of claim 1, wherein the instructions further cause the processor to generate a composite image based on first images captured while the imaging device is in the first angle range and second images captured while the imaging device is in the second angle range.

8. An imaging device comprising:
the control device of claim 1; and
an image sensor controlled by the control device.

9. A mobile object comprising:
the imaging device of claim 8; and
a support mechanism configured to support the imaging device and control an attitude of the imaging device.

10. A control device comprising:
a processor; and
a storage medium storing instructions that, when executed by the processor, cause the processor to:
control an imaging device to capture a plurality of images during a movement of the imaging device along a trajectory;
determine a target position of the imaging device satisfying a predetermined condition based on the plurality of images; and
control the imaging device to perform additional image capturing while further moving along the trajectory, including:
performing image capturing at a first image capture distance rate while the imaging device is in a first range of the trajectory not including the target position; and
performing image capturing at a second image capture distance rate while the imaging device is in a second range of the trajectory including the target position, the second image capture distance rate corresponding to more images captured per unit movement distance than the first image capture distance rate.

11. The control device of claim 10, wherein the instructions further cause the processor to determine the target position based on a contrast evaluation value derived from the plurality of images.

12. The control device of claim 10, wherein the instructions further cause the processor to generate a composite image based on first images captured while the imaging device is in the first range and second images captured while the imaging device is in the second range.

13. The control device of claim 10, wherein the instructions further cause the processor to control a number of images captured by the imaging device per unit movement distance by controlling a frame rate of the imaging device or a moving speed of the imaging device.

14. An imaging device comprising:
the control device of claim 10; and
an image sensor controlled by the control device.

15. A mobile object comprising:
the imaging device of claim 14; and
a support mechanism configured to support the imaging device and control an attitude of the imaging device.

16. A control device comprising:
a processor; and
a storage medium storing instructions that, when executed by the processor, cause the processor to:
control a measuring device to measure a plurality of measurement values during a change of a measurement direction of the measuring device, the measuring device being configured to measure an object present in an imaging direction of an imaging device;
determine a target measurement direction of the measuring device satisfying a predetermined condition based on the plurality of measurement values; and
control the imaging device to perform image capturing while changing the imaging direction corresponding to the change of the measurement direction, including:
performing image capturing at a first image capture angle rate while the imaging direction is in a first angle range not including the target measurement direction; and
performing image capturing at a second image capture angle rate while the imaging direction is in a second angle range including the target measurement direction, the second image capture angle rate corresponding to more images captured per unit angle than the first image capture angle rate.

17. An imaging device comprising:
the control device of claim 16; and
an image sensor controlled by the control device.

18. A mobile object comprising:
the imaging device of claim 17; and
a support mechanism configured to support the imaging device and control an attitude of the imaging device.

19. A control device comprising:
a processor; and
a storage medium storing instructions that, when executed by the processor, cause the processor to:
control a measuring device to measure a plurality of measurement values during a movement of the measuring device along a trajectory;
determine a target measurement position of the measuring device satisfying a predetermined condition based on the plurality of measurement values; and
control an imaging device to perform image capturing while moving along the trajectory, including:
performing image capturing at a first image capture distance rate while the imaging device is in a first range of the trajectory not including the target measurement position; and
performing image capturing at a second image capture distance rate while the imaging device is in a second range of the trajectory including the target measurement position, the second image capture distance rate corresponding to more images captured per unit movement distance than the first image capture distance rate.

20. An imaging device comprising:
the control device of claim 19; and
an image sensor controlled by the control device.
